(19) United States
(12) Patent Application Publication
(10) Pub. No.: US 2021/0231981 A1
(43) Pub. Date: Jul. 29, 2021

(54) ELECTROCHROMIC GLASS HYSTERESIS COMPENSATION FOR IMPROVED CONTROL ACCURACY

(71) Applicant: SAGE Electrochromics, Inc., Faribault, MN (US)

(72) Inventors: Yigang Wang, Maple Grove, MN (US); Thomas Doublein, Saint Paul, MN (US); Carlijn L. Mulder, Minneapolis, MN (US); Frank McGrogan, Fairbault, MN (US); Hannah Leung Ray, Minneapolis, MN (US); Peter Bocek, Northfield, MN (US)

(73) Assignee: SAGE Electrochromics, Inc., Faribault, MN (US)

(21) Appl. No.: 17/154,942

(22) Filed: Jan. 21, 2021

Related U.S. Application Data
(63) Continuation of application No. 62/965,355, filed on Jan. 24, 2020.

(51) Int. Cl. G02F 1/01; G02F 1/163

(52) U.S. Cl. CPC G02F 1/0123; G02F 1/163

(57) ABSTRACT

This disclose describes systems, methods and non-transitory computer readable media for controlling operations of an EC device with compensation for the hysteresis effect of the leakage current. A control module, coupled to the EC device, may be configured to develop a hysteresis model representing a hysteresis effect of a leakage current of the EC device, track one or more prior operating histories of the EC device, and transition the EC device to a target transmission level with compensation for the hysteresis effect of the leakage current based in part on a current transmission level, the one or more prior operating histories, and the hysteresis model of the EC device.

This application claims benefit of priority to U.S. Provisional Application Ser. No. 62/965,355, entitled “ELECTROCHROMIC GLASS HYSTERESIS COMPENSATION FOR IMPROVED CONTROL ACCURACY,” filed Jan. 24, 2020, and which is incorporated herein by reference in its entirety.

### BACKGROUND

An electrochromic (EC) device can change its optical properties such as optical transmission, absorption, reflectance and/or emittance in a continual but reversible manner on application of voltage. This property enables the EC device to be used for applications like smart glasses, electrochromic mirrors, and electrochromic display devices. Control accuracy of transmission levels (or tint levels) of an EC device depends on regulating the charge density of the EC device. Traditionally, this translates to estimating and controlling an applied voltage, which corresponds to a target charge density typically based on a predetermined formula, for the EC device. Researches identified that EC devices may possess a hysteretic voltage pattern. Depending on the operating history of an EC device, the voltage may vary for a given transmission level. For example, if an EC device transitions from full clear to 20% transmission, the EC device may need 1.0 V voltage to hold the EC device at the 20% equilibrium state. Alternatively, if the same device transitions from full tint to 20% transmission, it may only need 0.8 V holding voltage. The voltage hysteresis needs to be compensated for to achieve precise transmission control on EC devices. However, besides voltages hysteresis, an EC device may also have a hysteresis effect of the leakage current. But existing control schemes of EC devices do not recognize and compensate for the hysteretic leakage current. Thus, it is desirable to have control systems and approaches to incorporate leakage current hysteresis mitigation to improve control performance for EC devices.

### BRIEF DESCRIPTION OF THE DRAWINGS

FIG. 1 is a block diagram showing an exemplary EC system, according to some embodiments.

FIG. 2 is a simplified equivalent circuit of an EC device, according to some embodiments.

FIG. 3 is a flowchart showing an exemplary approach for developing a leakage current hysteresis model for an EC device, according to some embodiments.

FIG. 4 shows exemplary waveforms of a leakage current of an EC device, according to some embodiments.

FIG. 5 is a flowchart showing an exemplary charge-counting based approach for controlling an EC device, according to some embodiments.

FIG. 6 is a flowchart showing an exemplary voltage-based approach for controlling an EC glass device, according to some embodiments.

While embodiments are described herein by way of example for several embodiments and illustrative drawings, those skilled in the art will recognize that the embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). The words “include,” “including,” and “includes” indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for nouns that they precede, and do not imply any type of ordering (e.g., spatial, temporal, logical, etc.) unless such an ordering is otherwise explicitly indicated.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION

In various embodiments, systems, methods and non-transitory computer readable media may be provided to control operations of an EC device with compensation for the hysteresis effect of the leakage current. According to some embodiments, a system may comprise a control module coupled to the EC device. The control module may be configured to develop a hysteresis model representing a hysteresis effect of a leakage current of the EC device, track one or more prior operating histories of the EC device, and transition the EC device to a target transmission level with compensation for the hysteresis effect of the leakage current based in part on a current transmission level, the one or more prior operating histories, and the hysteresis model of the EC device.

According to some embodiments, a method may comprise developing a hysteresis model, by a control module coupled to an EC device, to represent a hysteresis effect of a leakage current of the EC device, tracking one or more prior operating histories of the EC device, and transitioning the EC device to a target transmission level with compensation for the hysteresis effect of the leakage current based in part on a current transmission level, the one or more prior operating histories, and the hysteresis model of the EC device.

According to some embodiments, a non-transitory computer readable medium storing instructions which, when executed by one or more processors, may cause the one or more processors to develop a hysteresis model representing a hysteresis effect of a leakage current of an EC device, track one or more prior operating histories of the EC device, and transition the EC device to a target transmission level with compensation for the hysteresis effect of the leakage current based in part on a current transmission level, the one or more prior operating histories, and the hysteresis model of the EC device.

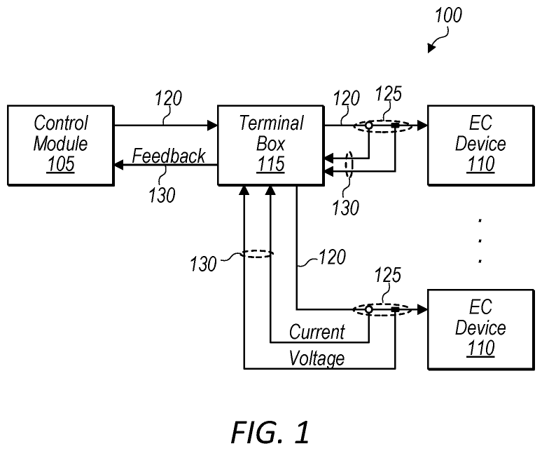

FIG. 1 shows exemplary EC system 100, according to some embodiments. As shown in FIG. 1, EC system 100 may include control module 105 coupled with EC device 110. Control module 105 may be housed, for example, in a control panel. Control module 105 may include one or more power supplies, controllers, and data acquisition systems. The one or more controllers each may further have one or more processors and memory. Control module 105, in particular, its one or more power supplies, may receive electric power, for example, from external outlets, and provide output voltages to EC device 110 under instructions of control module 105's controllers. EC device 110 may be installed within a window frame, for instance, to implement a smart glass. Control module 105 and EC device 110 may be coupled through one or more components, such as terminal box 115 and cables 120. Terminal box 115 may be a junction box for interfacing cables between control module 105 and EC device 110, which may be useful especially when control module 105 controls multiple EC devices 110 as shown in FIG. 1.

Cable 120 may carry voltages and currents from control module 105 to EC device 110. EC system 100 may use different cables 120 to fit corresponding voltage and/or current levels. For example, EC system 100 may use a 12-conductor bundled cable to connect control module 105 with terminal box 115, and thinner frame cables from terminal box 115 to EC device 110. Moreover, control module 105 may monitor a total current iₜₒₜₐₗ flowing through EC device 110 and/or an applied voltage v_{applied} across EC device 110. The current and/or voltage may be captured by respective sensors 125 and then fed back to control module 105 via sensing cables 130. Here, the term “applied voltage” may refer to a voltage at a substantially close proximity of EC device 110. This way, the applied voltage is or near the actual voltage applied across the EC device. For instance, the applied voltage v_{applied} may be measured at points connecting frame cables (from terminal bot 115) and pigtails (running around the window frames of EC device 110). Note that, for the purpose of illustrating, FIG. 1 is only a simplified diagram showing basic configurations of an EC system. In some embodiments, EC system 100 may include one or more additional components not shown in FIG. 1. Further, in some embodiments, besides terminal box 115 and cables 120, control module 105 may be coupled with EC device 110 through various wired (e.g., through cables, wires, contacts, transformers, optical fibers, etc.) and/or wireless connections.

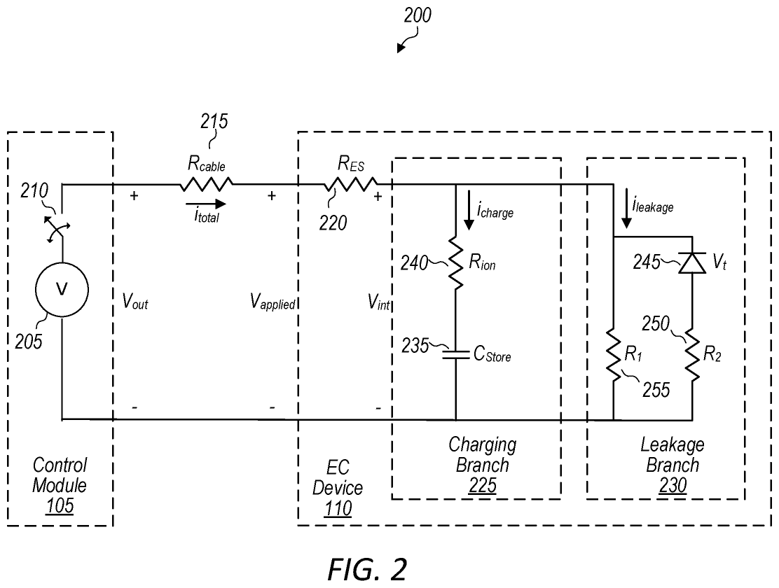

To facilitate the understanding of the hysteretic leakage current, FIG. 2 shows a simplified equivalent circuit of EC device 110, according to some embodiments. For the purpose of illustration, FIG. 2 illustrates equivalent circuit 200 for EC system 100 of FIG. 1. In FIG. 2, control module 105 of FIG. 1 may be modeled as voltage source 205. Control module 105 may employ switch 210 to enable or disable the provision of voltage/current to EC device 110. For instance, control module 105 may close switch 210 to provide an output voltage vₒᵤₜ or alternatively open switch 210 to create an open circuit. When vₒᵤₜ is applied, it may deduce a total current iₜₒₜₐₗ flowing through EC device 110, which may also accompany an applied voltage v_{applied} on EC device 110. As shown in FIG. 1, the applied voltage v_{applied} may be determined, for instance, according to equation (1):

v_{applied}=vₒᵤₜ−R_{cable}×iₜₒₜₐₗ (1)

where R_{cable} corresponds to resistance 215 associated with the connections between control module 105 and EC device 1110. For example, resistance 215 may include resistances associated with terminal box 115, cables 120, and the one or more additional components in-between. To simplify the illustration, FIG. 2 only depicts one lump-sum resistance. In reality, the connections between control module 105 and EC device 110 may have distributed resistance, inductance and/or capacitance.

Electrical performance of EC device 110 of FIG. 1 may be analyzed based on equivalent circuit 200, as shown in FIG. 2. Equivalent circuit 200 may include resistance 220 in series with charging branch 225 and leakage branch 230. Resistance 220 may include resistance associated with wires, contacts, and bus bars, and equivalent internal resistance of EC device 110. Charging branch 225 may be coupled in parallel with leakage branch 230. Charging branch 225 may have serially connected capacitance 235 and resistance 240. Capacitance 235 is important because it may represent an equivalent internal capacitance of EC device 110 for storing charges. As described below, the crux of transmission levels control for EC device 110 is to regulate the EC device's charge density—the charge density of capacitance 235. Leakage branch 230 corresponds to the portion of EC device 110 which causes the leakage current. As shown in FIG. 2, leakage branch 230 may include diode 245 in series with resistance 250, the two of which may further be coupled paralleled with resistance 255. Equivalent circuit 200 uses these two paralleled circuits with diode 245 to simulate the hysteresis effect of the leakage current. Diode 245 may have a threshold voltage vₜ. When the voltage across leakage branch 230 is less than vₜ, diode 245 may block the leakage current i_{leakage} through resistance 250. Thus, leakage current i_{leakage} can only flow through resistance 255. Conversely, when the voltage of leakage branch 230 exceeds vₜ, diode 245 may become conducted and leakage current i_{leakage} will flow through both resistances 250 and 255. This is because generally the leakage current i_{leakage} may increase linearly with voltage up to a threshold voltage, beyond which the current may increase much more rapidly. For purposes of illustration, FIG. 2 depicts the hysteretic leakage current of EC device 110 in lump-sum by using only one leakage branch 230. EC device 110 may actually include multiple leakage branches 230 (not shown), each of which may have identical and/or different resistance 250/255 and diode 245.

According to equivalent circuit 200, several electrical variables associated with the operations of EC device 110 may be determined. For instance, the charge density of EC device 110 may be determined, for instance, according to equation (2):

p=(Q_{ini.}−ΔQ)/A (2)

where p represents the charge density, [symbol] ᵢₙᵢ corresponds to an initial amount of charges, Δ [symbol] represents an amount of charges transferred by charging current i_{charge}, and A is the area of EC device 110. Further, the amount of charges Δ [symbol] moved by leakage current i_{charge} may be estimated as an integration of charging current i_{charge}, for example, according to equation (3):

ΔQ=∫i_{charge}dt (3)

Moreover, as shown in FIG. 2, charging current i_{charge} of EC device 110 may be determined based on the total current iₜₒₜₐₗ and leakage current i_{leakage}, according to equation (4):

i_{charge}=iₜₒₜₐₗ−i_{leakage} (4)

In view of equations (2)-(4), one way to control transitioning of transmission levels for EC device 110 is based on counting the mount of charges ΔQ (hereinafter “charge-counting” approach). For instance, control module 105 may measure the total current iₜₒₜₐₗ. If the leakage current i_{leakage} is known, control module 105 may determine the charge current i_{charge} based on the total current iₜₒₜₐₗ and leakage current i_{leakage}, for instance, according to equation (4). Responsive to determining the charge current i_{charge}, control module 105 may further estimate the amount of charges ΔQ, for example, according to equation (3). Assuming the initial amount of charges [symbol] ᵢₙᵢ for a given transmission level is known, control module 110 may determine whether EC device 110 reaches a target charge density based on Qini and ΔQ, for example, according to equation (2). In other words, if the leakage current i_{leakage} is known, control module 105 may control transitioning of EC device 110 by monitoring the total current iₜₒₜₐₗ and counting the amount of charge ΔQ. As described above, the leakage current i_{leakage} of EC device 110 may possess a hysteretic pattern—for a given transmission level, the leakage current i_{leakage} may have a hysteresis effect. Thus, control module 105 may include compensation for the hysteresis effect—varying the leakage current i_{leakage} based on the current transmission level and prior operating history—to achieve a more precise estimation of ΔQ. With the mitigation of the hysteretic leakage current, the performance of the charge-counting approach may be improved.

Once EC device 110 arrives at a target charge density, control module 110 may change the output voltage vₒᵤₜ to a target output voltage vₒᵤₜ*. The target output voltage vₒᵤₜ* may be determined based on creating a target applied voltage v_{applied}* for holding EC device 110 at the equilibrium charge density associated with the target transmission level. As described above, the charge density may be impacted by the hysteresis effect of the leakage current i_{leakage}. Thus, control module 105 may also mitigate the effect of the hysteretic leakage current at the holding state. For instance, control module 105 may determine the target applied voltage v_{applied}* according to equation (5), according to some embodiments:

v_{applied}*=(VTₗₑᵥₑₗ×Chargeᵣₐₜᵢₒ)+Charge_{offset}−Hᵥ−Hᵢ (5)

where VTₗₑᵥₑₗ is a parameter determined by transmission levels, Chargeᵣₐₜᵢₒ and Charge_{offset} are (empirical) constant values, and Hᵥ and Hᵢ represent compensations for hysteretic voltage and leakage current, respectively. For the purpose of illustration, this disclosure will focus on compensation for the hysteretic leakage current. One with skills in the art should appreciate that control module 105 may selectively mitigate the voltage hysteresis, leakage current hysteresis, or both. Hᵢ may include compensation for voltage drops on resistance 215 (R_{cable}—mostly known in field operations) caused by i_{leakage}. Further, because Hᵢ aims at compensating for losses of charges caused by the leakage current i_{leakage}, once i_{leakage} is known, Hᵢ may be determined accordingly as well, according to some embodiments. When the target holding voltage v_{applied}* is determined, the target output voltage vₒᵤₜ* may be calculated, for instance, according to equation (1). Again, by mitigating the hysteresis effect of the leakage current, control module 105 may improve the performance of holding EC device 110 at equilibrium states.

Besides the charge-counting approach described above, control module 105 may also employ a voltage-based method to control transitioning of EC device 110. In the voltage-based scheme, control module 105 may measure an open-circuit voltage v_{oc} (rather than the total current iₜₒₜₐₗ). Since no current flows through EC device 110 in open circuit, the open-circuit voltage v_{oc} may represent a voltage directly across capacitance 235. The relationship between the voltage of capacitance 235 and its charge density may be approximated, for instance, by equation (6):

p=Q/A=Cv_{oc}/A=εv_{oc}/d (6)

where p represents the charge density, [symbol] represents the amount of charges, A is the area, ε represents an equivalent permittivity, and d corresponds to an equivalent distance between the two plates of EC device 110. The relationship between v_{oc} and p may be determined in a characterization phase of EC device 110 based on, for instance, technical specifications, laboratory testing, and/or empirical formula of the EC device. In field operations, control module 105 may predict the charge density p of EC device 110 based on the open-circuit voltage v_{oc}. It is noticeable that the measurement of open-circuit voltage v_{oc} requires removal of control module 105, for example, by opening switch 210 of FIG. 2 as described above. Isolating control module 105 from EC device 110 may cause flickers in the tintness of EC device 110, which may be undesired in practical use. Thus, according to some embodiments, control module 105 may utilize the voltage-based approach to control transitioning of EC device 110. Once EC device 110 reaches a target transmission level, control module 105 may switch to provide a target output voltage vₒᵤₜ* in order to create the corresponding target applied voltage v_{applied}*—same as described above with regards to the charge-counting approach. This way, the flickers may be retained in transients only without affecting customer experience at holding states. Similarly, control module 105 may mitigate the hysteresis effect of the leakage current at the holding state, for instance, according to equation (5).

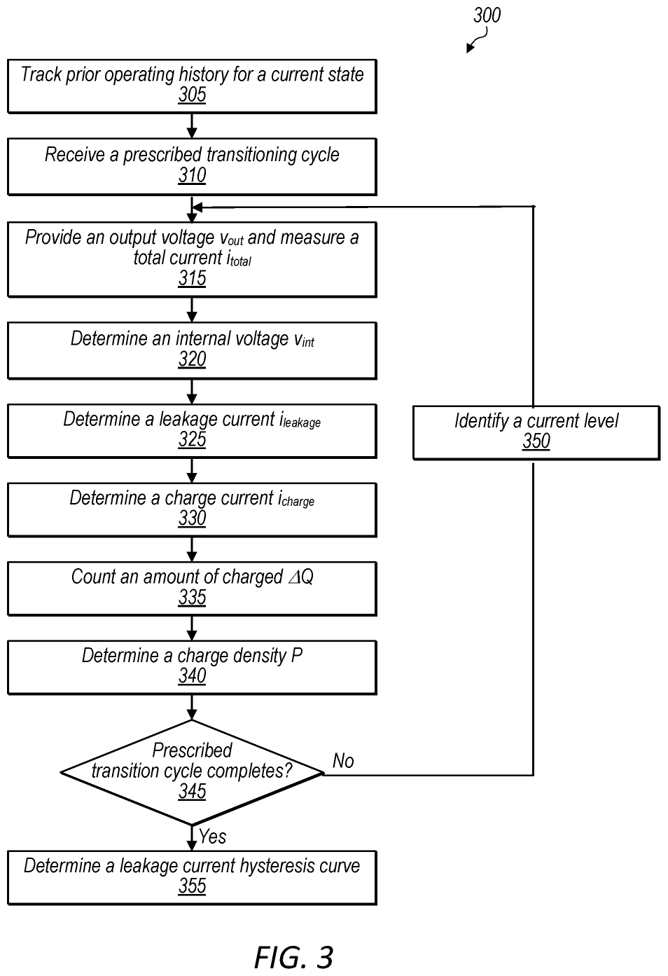

The hysteresis effect of the leakage current of EC device 110 may be represented by a hysteresis model, for instance, in the characterization phase of the EC device. FIG. 3 shows example process 300 to establish a hysteresis model for EC device 110, according to some embodiments. As shown in FIG. 3, control module 105 may first track a prior operating history of EC device 110 (block 305). The history may include one or more prior operating circumstances of EC device 110. For example, if EC device 110 reached a current transmission level from a prior transmission level, control module 105 may keep a record of the current transmission level, the prior transmission level, and/or a transitioning rate (or speed) of the prior transitioning. Next, control module 105 may receive a command prescribing transitioning EC device 110 from the current transmission level to a target transmission level (block 310). Control module 105 may provide an output voltage vout and measure the total current iₜₒₜₐₗ (block 315). Control module 105 may then determine an internal voltage vᵢₙₜ, for instance, according to equation (7):

vᵢₙₜ=vₒᵤₜ−(R_{cable}+R_{ES})×iₜₒₜₐₗ (7)

where R_{cable} and R_{ES} represent to resistances 215 and 220 of FIG. 2, respectively. According to the behavior of the hysteretic leakage current described above with regards to FIG. 2, control module 105 may determine a leakage current i_{leakage} based in part on vᵢₙₜ and parameters of EC device 110, for instance, according to equation (8) (block 325):

$$\{ \begin{matrix}if {v}_{i n t} < {v}_{t} , {i}_{leakage} = {v}_{i n t} / {R}_{1} ; \\ if {v}_{i n t} \geq {v}_{t} , {i}_{leak a g e} = {v}_{i n t} / {R}_{1} + ( {v}_{i n t} - {v}_{t} ) / {R}_{2}\end{matrix} \qquad ( 8 )$$

The leakage current i_{leakage} gives one point of measurement. Next, control module 105 may determine a charge current i_{charge}, for instance, according to equation (4) (block 330). Based on i_{charge}, control module 105 may count an amount of charge Δ [symbol] , for example, according to equation (3) (block 335). Control module 105 may next determine a charge density p, for example, according to equation (2) (block 340). Control module 105 may detect whether the prescribed transitioning cycle completes—whether EC device 110 arrives at a charge density associated with the prescribed transmission level (block 345). If not, control module 105 may identify (and memorize) the current transmission level associated with the determined i_{leakage} (block 350) and repeat the process to determine the leakage current i_{leakage} at one or more additional operating points as described above. Conversely, if the prescribed transitioning cycle is finished, control module 105 may develop a curve, for instance, based on the determined points of i_{leakage} (block 355). As described above, once i_{leakage} is determined, compensation Hᵢ of equation (5) may be determined accordingly as well. The curve and Hᵢ together may form a hysteresis model representing the hysteresis effect of the leakage current for EC device 110. Note that the hysteresis model may comprise a set of curves to develop a more comprehensive model covering a range of operating histories and operating circumstances. Further, control module 105 may repeatedly perform process 300 in field operations to continuously calibrate and update the hysteresis model to accommodate changes of the leakage current hysteresis caused by, for example, environmental temperatures, aging of the EC device, etc.

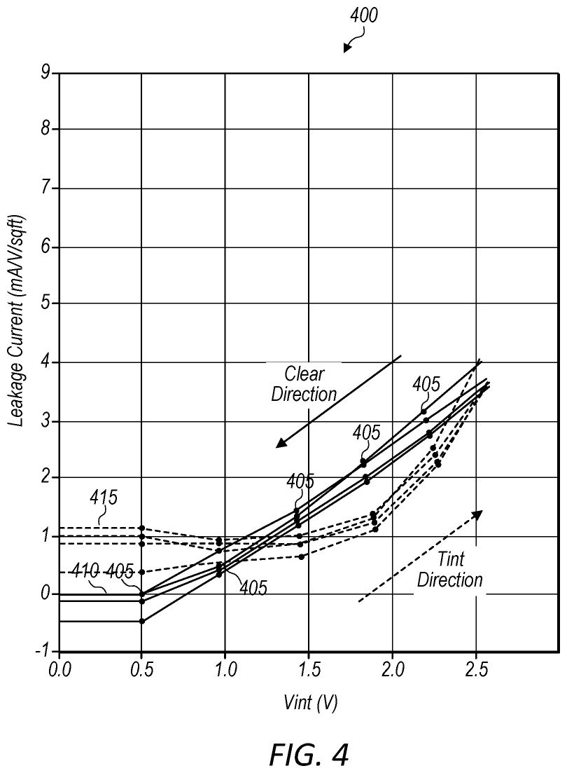

FIG. 4 shows example waveforms 400 of the leakage current i_{leakage} of EC device 110, according to some embodiments. In FIG. 4, the horizontal axis represents an internal voltage vᵢₙₜ of EC device 110, and the vertical axis corresponds to a leakage current i_{leakage}. FIG. 4 depicts curves representing relationships between i_{leakage} vs. vint under different operating circumstances. The curves may be established, for instance, according to process 300 as described above with regards to FIG. 3. For example, control module 105 may determine i_{leakage} at a set of operating points 405 in a clear transitioning (i.e., reducing opacity) with a first history. Control module 105 may then form curve 410 based on i_{leakage} at points 405, for instance, with piece-wise linear approximation. Similarly, control module 105 may develop curve 415 for a tint transitioning (i.e., increasing opacity) with a second history. As shown in FIG. 4, leakage current i_{leakage} displays a hysteresis pattern in both clear and tint directions. For example, at vᵢₙₜ of 0.5 V (corresponding to one transmission level), the leakage current i_{leakage} may vary from 1.1 to (−0.5) Amperes caused by associated prior histories.

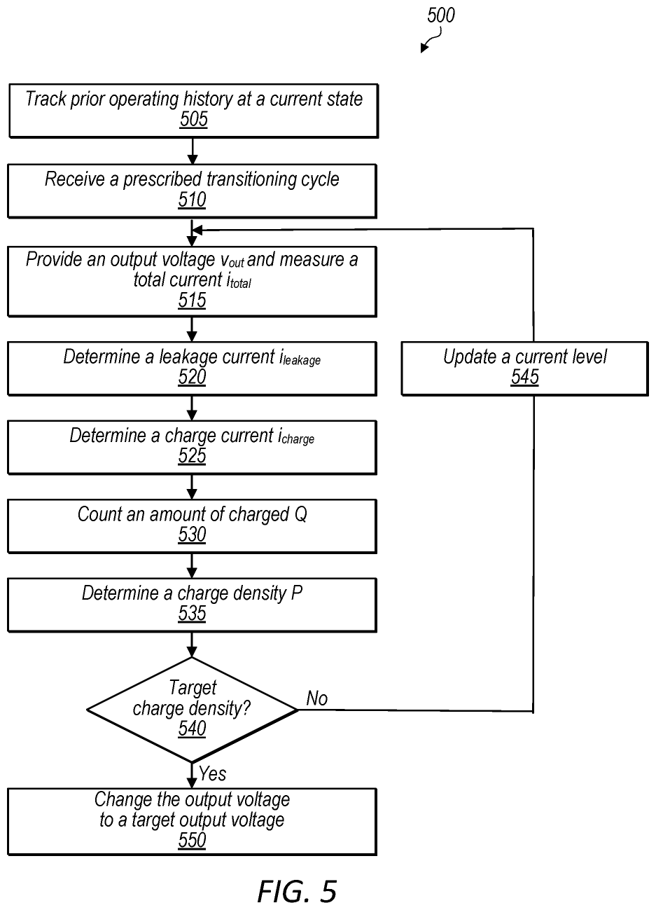

Once developed, control module 105 may deploy the hysteresis model to field operations to control EC device 110, for instance, with charge-counting based or voltage-based approaches as described above. FIG. 5 is a flowchart showing the charge-counting based process 500 in field operations. As shown in FIG. 5, control module 105 first may track a prior operating history at a current state (block 505). The history may include one or more prior operating circumstances of EC device 110. For example, if EC device 110 reached a current transmission level from a prior transmission level, control module 105 may keep a record of the current transmission level, the prior transmission level, and/or a transitioning rate (or speed) of the prior transitioning. Next, control module 105 may receive a command prescribing transitioning EC device 110 from the current transmission level to a target transmission level (block 510). Control module 105 may provide an output voltage vₒᵤₜ and measure a total current iₜₒₜₐₗ (block 515). Control module 105 may determine a leakage current i_{leakage} based on the prior history and the transmission level (520). For instance, at beginning of process 500, control module 105 may determine i_{leakage} based on the prior history and the current transmission level. Once the transmission level is updated (as described below), control module may update i_{leakage} accordingly. If the hysteresis model happens to include a point corresponding to i_{leakage} at the current transmission level with the prior history, control module 105 may determine i_{leakage} by mapping the current transmission level and prior history to the specific operating point. If the hysteresis model does not include the exact operating point, control module 105 may determinate i_{leakage} based on, for instance, interpolation or averaging of i_{leakage} of one or more other points residing closely to the specific operating point. By determining i_{leakage} based on the prior history, control module 105 may mitigate the hysteresis effect of the leakage current. Once i_{leakage} is determined, control module 105 may determine the charge current i_{charge}, for instance, according to equation (4) (block 525).

Next, control module 105 may count an amount of charges ΔQ and determine a charge density p, for instance, according to equations (2)-(3), respectively (blocks 530 and 535). Control module 105 may detect whether EC device 110 reaches a target charge density associated with the prescribed target transmission level (block 540). If not, control module 105 may update the current transmission level to the new level and repeat the above described process (block 545). As described above, with the updated transmission level, control module 105 may determine an updated i_{leakage} based on the prior history and the updated transmission level (block 520). Process 500 may repeat until EC device 110 arrives at the target charge density. Next, control module 105 may change to provide a target output voltage vₒᵤₜ* to create the target applied voltage v_{applied}*, for instance, according to equation (5), to hold EC device 110 at the equilibrium state with the prescribed target transmission level (block 550). As described above, control module 105 may mitigate the leakage current hysteresis in calculations of the target output voltage vₒᵤₜ*.

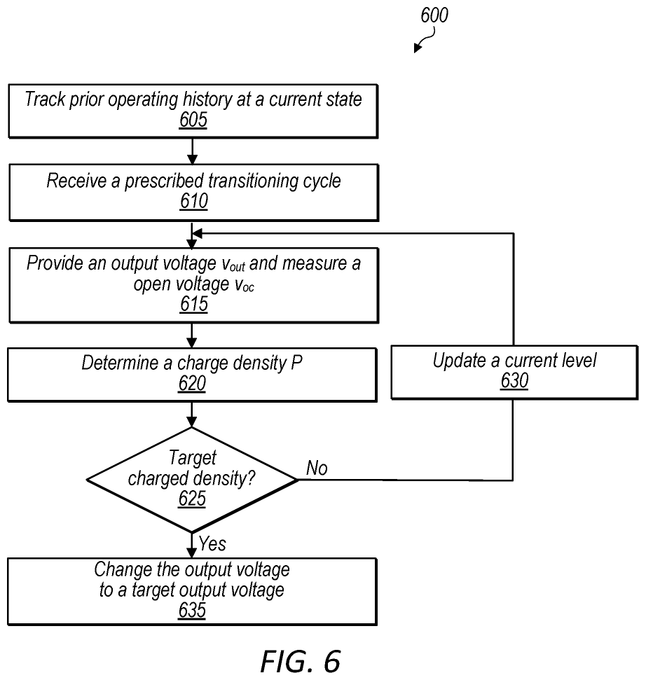

FIG. 6 is a flowchart showing the voltage-based process 600 in field operations. As shown in FIG. 6, control module 105 may first track a prior operating history at a current state (block 605). The history may include one or more prior operating circumstances of EC device 110. For example, if EC device 110 reached a current transmission level from a prior transmission level, control module 105 may keep a record of the current transmission level, the prior transmission level, and/or a transitioning rate (or speed) of the prior transitioning. Next, control module 105 may receive a command prescribing transitioning EC device 110 from the current transmission level to a target transmission level (block 610). Control module 105 may provide an output voltage vₒᵤₜ and measure an open-circuit voltage v_{oc} (block 615). As described above, the measurement of v_{oc} may be implemented by isolating control module 105 from EC device 110. Control module 105 may determine a charge density p based on v_{oc}, as describe above with regards to equation (6) (620). Control module 105 may detect whether EC device 110 reaches a target charge density associated with the prescribed target transmission level (block 625). If not, control module 105 may update the transmission level and repeat the above process (block 630). Process 500 may repeat until EC device 110 arrives at the target charge density. Next, control module 105 may change to provide a target output voltage vₒᵤₜ* to create the target applied voltage v_{applied}*, for instance, according to equation (5), to hold EC device 110 at the equilibrium state with the prescribed target transmission level (block 550). As described above, control module 105 may mitigate the leakage current hysteresis in calculations of the target output voltage vₒᵤₜ*.

The various methods as illustrated in the figures and described herein represent example embodiments of methods. The methods may be implemented manually, in software, in hardware, or in a combination thereof. The order of any method may be changed, and various elements may be added, reordered, combined, omitted, modified, etc.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed is:

1. A system for controlling operations of an electrochromic (EC) device, comprising:
a control module coupled to an EC device, the control module configured to:
develop a hysteresis model representing a hysteresis effect of a leakage current of the EC device;
track one or more prior operating histories of the EC device; and
transition the EC device to a target transmission level with compensation for the hysteresis effect of the leakage current based in part on a current transmission level, the one or more prior operating histories, and the hysteresis model of the EC device.

2. The system of claim 1, wherein to develop the hysteresis model, the control module is configured to:
receive a prescribed transitioning cycle specifying to transition the EC device from a first transmission level to a second transmission level;
provide an output voltage and measuring a total current through the EC device;
determine the leakage current of the EC device at one or more points during transitioning from the first transmission level to the second transmission level based in part on the total current, the output voltage, and parameters of the EC device; and
determine a curve of the leakage current and a compensation value Hᵢ based on the leakage current at the one or more points to form a hysteresis model representing the hysteresis effect of the leakage current.

3. The system of claim 2, wherein the control module is further configured to:
repeat the prescribed transitioning of the EC device from the first transmission level to the second transmission level;
update the leakage current of the EC device at one or more points during transitioning from the first transmission level to the second transmission level based in part on the total current, the output voltage, and parameters of the EC device; and
update the curve of the leakage current and a compensation value Hᵢ based on the updated leakage current at the one or more points to updated the hysteresis model representing the hysteresis effect of the leakage current.

4. The system of claim 1, wherein to track the one or more recent operations of the EC device, the control module is configured to:
monitor respective transmission levels associated with the one or more prior operating histories of the EC device;
monitor respective transitioning rates associated with the one or more prior operating histories of the EC device; and
create a record of the one or more prior operating histories based on the respective transmission levels and transitioning rates.

5. The system of claim 1, wherein to transition the EC device to a target transmission level, the control module is configured to:
measure a total current through the EC device;
determine the leakage current of the EC device based in part on the current transmission level, the one or more prior operating histories, and the hysteresis model of the EC device;
count an amount of charge based on the total current and leakage current;
detect whether the EC device reaches a target charge density associated with the target transmission level based in part on the counted amount of charge; and
change an output voltage to a target output voltage responsive to detecting that the EC device reaches the target charge density associated with the target transmission level.

6. The system of claim 5, wherein to transition the EC device to a target transmission level, the control module is further configured to:
responsive to detecting that that the EC device does not reach the target charge density associated with the target transmission level, update the current transmission level based in part on the counted amount of charge; and
determine the leakage current of the EC device based in part on the updated current transmission level, the one or more prior operating histories, and the hysteresis model of the EC device.

7. The system of claim 5, wherein the target output voltage is determined based on a target applied voltage of the EC device, and wherein the target applied voltage is determined based the current transmission level, the one or more prior operating histories, and the hysteresis model of the EC device.

8. The system of claim 1, wherein to transition the EC device to a target transmission level, the control module is configured to:
measure an open-circuit voltage of the EC device;
detect whether the EC device reaches a target charge density associated with the target transmission level based in part on the open-circuit voltage; and
change the output voltage to a target output voltage responsive to detecting that the EC device reaches the target charge density associated with the target transmission level.

9. A method for controlling operations of an EC device, comprising:
developing a hysteresis model, by a control module coupled to an EC device, which represents a hysteresis effect of a leakage current of the EC device;
tracking, by the control module, one or more prior operating histories of the EC device; and
transitioning the EC device, by the control module, to a target transmission level with compensation for the hysteresis effect of the leakage current based in part on a current transmission level, the one or more prior operating histories, and the hysteresis model of the EC device.

10. The method of claim 9, wherein developing a hysteresis model comprises:
receiving a prescribed transitioning cycle specifying to transition the EC device from a first transmission level to a second transmission level;
providing an output voltage and measuring a total current through the EC device;
determining the leakage current of the EC device at one or more points during transitioning from the first transmission level to the second transmission level based in part on the total current, the output voltage, and parameters of the EC device; and
determining a curve of the leakage current and a compensation value Hᵢ based on the leakage current at the one or more points to form a hysteresis model representing the hysteresis effect of the leakage current.

11. The method of claim 10, further comprising:
repeating, by the control module, the prescribed transitioning of the EC device from the first transmission level to the second transmission level;
updating the leakage current of the EC device, by the control module, at one or more points during transitioning from the first transmission level to the second transmission level based in part on the total current, the output voltage, and parameters of the EC device; and
updating the curve of the leakage current and a compensation value Hᵢ, by the control module, based on the updated leakage current at the one or more points to updated the hysteresis model representing the hysteresis effect of the leakage current.

12. The method of claim 9, wherein tracking the one or more recent operations of the EC device comprises:
monitoring respective transmission levels associated with the one or more prior operating histories of the EC device;
monitoring respective transitioning rates associated with the one or more prior operating histories of the EC device; and
creating a record of the one or more prior operating histories based on the respective transmission levels and transitioning rates.

13. The method of claim 9, wherein transitioning the EC device to a target transmission level comprises:
determining the leakage current of the EC device based in part on the current transmission level, the one or more prior operating histories, and the hysteresis model of the EC device;
counting an amount of charge based on the total current and leakage current;
detecting whether the EC device reaches a target charge density associated with the target transmission level based in part on the counted amount of charge; and
changing an output voltage to a target output voltage responsive to detecting that the EC device reaches the target charge density associated with the target transmission level.

14. The method of claim 13, wherein transitioning the EC device to a target transmission level further comprises:
responsive to detecting that that the EC device does not reach the target charge density associated with the target transmission level, updating the current transmission level based in part on the counted amount of charge; and
determining the leakage current of the EC device based in part on the updated current transmission level, the one or more prior operating histories, and the hysteresis model of the EC device.

15. The method of claim 13, wherein the target output voltage is determined based on a target applied voltage of the EC device, and wherein the target applied voltage is determined based the current transmission level, the one or more prior operating histories, and the hysteresis model of the EC device.

16. The method of claim 9, wherein transitioning the EC device to a target transmission level comprises:
measuring an open-circuit voltage of the EC device;
detecting whether the EC device reaches a target charge density associated with the target transmission level based in part on the open-circuit voltage; and
changing the output voltage to a target output voltage responsive to detecting that the EC device reaches the target charge density associated with the target transmission level.

17. A non-transitory computer readable medium storing instructions which, when executed by one or more processors, cause the one or more processors to:
develop a hysteresis model representing a hysteresis effect of a leakage current of an EC device;
track one or more prior operating histories of the EC device; and
transition the EC device to a target transmission level with compensation for the hysteresis effect of the leakage current based in part on a current transmission level, the one or more prior operating histories, and the hysteresis model of the EC device.

18. The non-transitory computer readable medium of claim 17, wherein to transition the EC device to a target transmission level, the non-transitory computer readable medium storing instructions which, when executed by the one or more processors, cause the one or more processors to:
measure a total current through the EC device;
determine the leakage current of the EC device based in part on the current transmission level, the one or more prior operating histories, and the hysteresis model of the EC device;
count an amount of charge based on the total current and leakage current;
detect whether the EC device reaches a target charge density associated with the target transmission level based in part on the counted amount of charge; and
change an output voltage to a target output voltage responsive to detecting that the EC device reaches the target charge density associated with the target transmission level.

19. The non-transitory computer readable medium of claim 18, wherein the target output voltage is determined based on a target applied voltage of the EC device, and wherein the target applied voltage is determined based the current transmission level, the one or more prior operating histories, and the hysteresis model of the EC device.

20. The non-transitory computer readable medium of claim 16, wherein to transition the EC device to a target transmission level, the non-transitory computer readable medium storing instructions which, when executed by the one or more processors, cause the one or more processors to:
measure an open-circuit voltage of the EC device;
detect whether the EC device reaches a target charge density associated with the target transmission level based in part on the open-circuit voltage; and
change the output voltage to a target output voltage responsive to detecting that the EC device reaches the target charge density associated with the target transmission level.
